(19) United States
(12) Patent Application Publication
(10) Pub. No.: US 2026/0177801 A1
(43) Pub. Date: Jun. 25, 2026

(54) Light microscope and method for an automatic focusing

(71) Applicant: Carl Zeiss Microscopy GmbH, Jena (DE)

(72) Inventors: Manuel Amthor, Jena (DE); Daniel Haase, Zoellnitz (DE); Thomas Ohrt, Golmsdorf (DE)

(21) Appl. No.: 19/365,340

(22) Filed: Oct. 22, 2025

(30) Foreign Application Priority Data
Dec. 20, 2024 (DE) 10 2024 139 248.7

(51) Int. Cl. G02B 21/24

(52) U.S. Cl. CPC G02B 21/242

(57) ABSTRACT

In a computer-implemented method for automatically focusing a light microscope, an experiment description is received that includes at least one textual description of a planned sample analysis. Based on this experiment description, experiment-specific information is determined in vectorized form and input into a machine-learned model in order to define parameters of a focus strategy that includes a coarse-focus strategy and a fine-focus strategy. Using the focus strategy, a data capture with the light microscope is initiated and monitored.

### REFERENCE TO RELATED APPLICATIONS

The current application claims the benefit of German Patent Application No. 10 2024 139 248.7, filed on 20 Dec. 2024, which is hereby incorporated by reference.

### FIELD OF THE DISCLOSURE

The present disclosure relates to a microscopy system and to a computer-implemented method for automatically focusing a light microscope.

### BACKGROUND OF THE DISCLOSURE

In general, microscopes are designed to capture images of a prepared specimen, wherein these images should be as sharp and as high-contrast as possible. Generally speaking, the most important imaging component in a light microscope is the objective. Objectives are responsible for the primary image generation and are decisive for the achievable image quality. The magnification and the resolution with which fine specimen details can be depicted also depend heavily on the objective used. The performance of an objective is decisive for the resulting image quality of the microscope along with various physical parameters such as, for example, the depth of field. Depth of field is a measure of the extension of the sharp area in the object space in the direction of detection, i.e. along the optical axis of an objective in use. The depth of field depends heavily on the numerical aperture (NA) of the objective. The larger the NA is, the smaller the depth of field. Microscope users often use objectives with a large NA to achieve a higher lateral resolution. However, as this reduces the depth of field, it becomes increasingly important for the user to always focus on exactly the same, i.e. on a specific plane.

In particular in the case of long-term experiments, it is difficult to maintain a specific focus plane over a longer period of time. For example, there is a risk of a z-drift of the focus due to the mechanical expansion of microscope components or of the sample or sample carrier during a heating phase of the microscope or due to intentionally induced, sudden changes in temperature. Similarly, in the case of large, extensive samples whose lateral areas are analyzed successively, maintaining a focus on a specific plane throughout these analyses is challenging. To accomplish this, the microscope must follow a focus strategy.

Various focus strategies for finding a specific or suitable focus and maintaining it over a longer period of time are known.

For example, in passive autofocus methods, the focus position can be monitored directly by means of captured microscope images by monitoring, for example, an image sharpness.

Active or indirect autofocus methods—such as, for example, ZEISS Definite Focus—monitor the distance between the objective and a bottom of a sample carrier by reflecting IR light from a special light source off the bottom of the sample carrier. If deviations in distance are detected, corresponding corrective movements can be carried out so that a specific focus plane can be maintained for, for example, long-term experiments.

Which of the autofocus methods are most suitable, which parameter values of the autofocus methods are most suitable, or whether a combination of more than one autofocus method is most suitable, depends on the employed sample as well as on the quality of the prepared specimen or sample carrier.

Which strategy will be successful, and with which settings, is not always clear to a less experienced microscope user nor easy to implement in an experiment. Even experts often have to test different autofocus settings for a while before a high-quality result is achieved.

Typically, the configuration of a focus strategy is carried out manually, in particular by microscope users who try out different settings. Programs (wizards) are known that simplify the selection of settings and focus methods. However, a high level of expertise is still required in order to use a wizard successfully. Detail settings of the focus strategy must also be carried out manually in this case.

For example, for focus strategies supported by a wizard, it is generally necessary to select an objective and a detection channel of the microscope manually and to check manually, after switching to live images, whether the illumination/exposure time is correct or needs modifying. The start and end values of a focus search range and a z-step size are also set manually. In software-based autofocus methods, a plurality of images of the same lateral/xy area are captured with a different z-focus. From one image to the next, the z-focus is adjusted by the z-step size, wherein together the images cover the focus search range. By evaluating the images according to, for example, image sharpness, a suitable focus setting is ascertained with which the sample is most clearly visible. In addition to the start and end of the focus search range and the z-step size, information relating to the reference points at which a focus is to be determined must also be entered manually. A wizard can, for example, offer the selectable options of using reference points at fine, medium or coarse intervals, whereby the number of reference points also varies accordingly. It is also necessary to specify the algorithm by means of which an image sharpness or another measure of the focus is to be evaluated quantitatively. Reference is made, for example, to the following article:

José María Mateos-Pérez et al., “Comparative Evaluation of Autofocus Algorithms for a Real-Time System for Automatic Detection of Mycobacterium tuberculosis”, Cytometry Part A 81A: 213 221, 2012

This article compares, for a specific sample type, 13 different algorithms of a software-based autofocus method in which the algorithm evaluates each image from a Z-stack in order to ascertain the best focused image. Different algorithms can determine, for example, the variance in the image, the energy or sum of all squared pixel intensities, or a variance based on the L1 norm. Which algorithm is most suitable depends largely on, for example, the employed sample, image noise and illumination characteristics. As a result, even experts are often only able to determine a suitable algorithm by trial and error. A pre-processing of the images also has a significant influence on the success of software-based autofocus methods. A pre-processing can include, for example, filters for noise reduction or artefact removal.

The manual effort required to date gives rise to uncertainty and frustration in some users. Although a part of the autofocus configuration can be automated using a wizard to make the autofocus configuration more time-efficient, it nevertheless remains essential that a user should have a deep understanding of the various autofocus technologies and setting options and know how to use them correctly.

A complete automation would in principle be possible through the use of standard settings. Standard settings can be acceptable for different samples. Generally speaking, however, standard settings cannot deliver ideal results and can even fail entirely with experiments that deviate to a greater degree from standard cases, so that not a single sharp sample image is obtained.

Automation approaches are known for sub-aspects in the definition of a focus strategy. For example, overview images can be evaluated in an automated manner in order to find suitable points or areas for a focus determination.

US 2014 0 210 980 A1 describes a method for automatically evaluating a microscope image to determine whether or not a sample has been stained with HE. Depending on the result, one of two autofocus methods is selected. In the case of an HE staining, a phase-difference autofocus method is used (in which a beam is split and a difference between the two partial beams provides information on an incorrect focus), while for samples with no HE staining, a contrast autofocus method is used (described in the foregoing as a software-based autofocus method). While this at least has the advantage of automating a sample-dependent choice between two focus methods, parameters of the focus methods are set independently of the current sample. These parameters can include, inter alia: number and location of autofocus reference points, focus search range and z-focus step size, as well as a time interval until a focus check in long-term experiments. As only the presence of a specific sample staining is taken into account, a fine adjustment of such parameters is not possible.

US 2020 0 371 335 A1 describes a focus strategy that is in particular suitable for low-contrast samples. First, a cover glass edge or other readily visible edge on a sample carrier is automatically localized in an overview image and subsequently used for a (software) coarse focusing. This is followed by a fine focusing using the sample. This focusing strategy can be particularly suitable for samples for which a software coarse-focusing method in the sample area is unlikely to produce a result due to a low contrast. It would be desirable to enable a tailored selection of the focusing strategy. For example, with high-contrast samples, the coarse focusing might be performed directly in the sample area, which would eliminate the time required in US 2020 0 371 335 A1 for the positioning of a cover glass edge.

Reference is made to U.S. Pat. No. 11,754,392 B2 as further technological background, which describes a macroscopic height estimation based on an overview image. DE 10 2023 125 820 B3 describes an automatic microscope control for which suitable microscope settings are derived from in particular (textual) user inputs using a large language model (LLM).

In principle, methods based on reinforcement learning would be conceivable for an automatic optimization of a focus strategy. However, this would not be feasible in the context of the present invention, since a complete experiment would have to be run after each modification of the focus strategy in order to evaluate whether the modification resulted in an improvement or a deterioration of the focus.

For a better understanding of the technical background of the invention, reference is made to different machine learning techniques below. For an effective processing of text data, in particular transformer-based large language models (LLMs) like GPT and BERT are used, as described, for example, in:
Brown, T., et al., “Language Models are Few-Shot Learners”, arXiv:2005.14165v4 [cs.CL] 22 Jul. 2020
Devlin, J., et al., “BERT: Pre-training of Deep Bidirectional Transformers for Language Understanding”, arXiv:1810.04805v2 [cs. CL] 24 May 2019

The transformer technology described in these articles can also be applied to image processing. A model known as VisionTransformer ViT, which uses a transformer for image processing, is described in:
Dosovitskiy, A., et al., “AN IMAGE IS WORTH 16×16 WORDS: TRANSFORMERS FOR IMAGE RECOGNITION AT SCALE”, arXiv:2010.11929v2 [cs.CV] 3 Jun. 2021

### SUMMARY OF THE DISCLOSURE

It can be considered an object of the invention to indicate a microscopy system and a method which define a focus strategy for a planned experiment in a manner that is both automated and tailored to the planned experiment.

This object is solved by the microscopy system and the method with the features of the independent claims.

In a computer-implemented method for automatically focusing a light microscope, an experiment description including at least one textual description pertaining to a planned sample analysis is received. Based on the experiment description, experiment-specific information is determined in vectorized form. The experiment-specific information in vectorized form is used as input into a machine-learned model for defining parameters of a focus strategy. The focus strategy includes a coarse-focus strategy and a fine-focus strategy with different parameters. After the definition of the parameters of the focus strategy, a data capture with the light microscope using the focus strategy is initiated and monitored.

A microscopy system of an embodiment according to the invention includes a microscope for image capture and a computing device that is configured to execute a computer-implemented method according to the invention.

The invention also relates to a non-volatile computer-readable data memory that includes a computer program with commands which, when executed by a computer, cause the computer to execute at least one computer-implemented method according to the invention.

Conventionally, numerous parameters of a focus strategy must be specified manually or, alternatively, constant standard values of parameters are used that do not take an experiment to be conducted into account. In contrast, the invention allows an individual definition of the focus strategy and its parameters as a function of a planned experiment and the provided sample. For this purpose, the use of extensive input data is advantageous, to which end an experiment description with a textual description of a planned sample analysis is (also) utilized, from which the information that is relevant for the focus strategy is extracted. In conventional autofocus methods, in contrast, only a small amount of sample-specific data, if any, is used for the definition of a focus strategy, so that a precise tailoring of the focus strategy to the provided sample and the planned experiment is not possible. For example, in methods cited in the introduction with reference to the prior art, a sample image is evaluated in order to determine whether a dye is present and, depending on the result of this evaluation, one of two autofocus methods is selected; in the absence of further exploitable information, the selected autofocus method cannot be adjusted further, for example with respect to free parameters such as illumination intensity, z-step size, focus search range or number and coordinates of focus reference points. The invention, on the other hand, allows extensive experiment-specific and sample-specific data to be mapped to all free parameters of the focus strategy by means of a machine-learned model.

This not only augments user comfort, but also improves the speed, robustness and reproducibility of imaging.

### Further Optional Designs

Variants of the invention are the object of the dependent claims and are explained in the following description.

### Experiment Description

An experiment description can contain at least textual information regarding the employed sample, properties of an image to be captured and/or information regarding successive processes.

Textual experiment descriptions can stem in particular from a user and can be written in natural or technical language. For example, a macro of a previous imaging or a log file that relates to the interaction between the user and the microscopy system can be written in technical language.

It is also possible for experiment descriptions to have been at least partially spoken and subsequently converted into text form using speech recognition software.

Together with a textual experiment description, it is optionally also possible to utilize further experiment-specific contextual information to calculate an embedding vector, i.e. experiment-specific information in vectorized form. The experiment-specific contextual information can be multimodal, i.e. it can include or be derived from non-textual data in addition to textual data. For example, an experiment description can include at least text data and image data, optionally also video data and/or acoustic data. As described by the Applicant in US20220382035A1, acoustic data can, for example, have been captured by at least one microphone on the microscope and can provide information regarding a type of sample carrier a user is positioning on the microscope (by distinguishing between the sounds that are made during the placing of different glass slides, microtiter plates, etc.). It is also possible to detect specific workflow noises, ambient noises or sample noises that provide information on an employed sample, an employed sample carrier, employed microscope components or planned sample analyses. For example, operating noises of an immersion unit for applying immersion fluid can be identified.

Image data can in particular include a macroscopic overview image of an employed sample carrier and/or sample. Image capture can be carried out, for example, with a macroscopic overview camera or using an objective with a low magnification. Any markings on the sample carrier can be detected and read in the overview image, for example barcodes or label areas on which, for example, the dyes present in the sample can be indicated. Alternatively or additionally, image data can also include a microscopic image of the sample or reference data of a previous image capture. It is also possible for image metadata to form part of the experiment description. Metadata can relate, for example, to the microscope components or microscope settings employed for the capture of an associated image.

Additionally or alternatively, image data can also contain segmentation masks or density maps for an image of the sample or sample carrier, for example in order to detect sample areas, cover glasses and/or sample carriers.

Video data can include sample images or overview images of a sample carrier captured in succession. Alternatively or additionally, video data can also include video documentation of previous images, wherein the video shows, for example, a computer screen display with a microscope-control software and software settings entered by a user.

### Experiment-Specific Information

Experiment-specific information is obtained in particular from the experiment description and is used to derive the focus strategy. The experiment-specific information can specify one, more than one, or all of the following:
Type and state of the sample, for example one or more employed cell types, a degree of overgrowth, employed dyes, an age of the sample, a position of the sample relative to a cover glass or to sample-carrier points of reference (wherein a position can be specified laterally/in the xy-direction or at least approximately in the z-direction), and/or a quality of the sample (for example geometric information such as flat, curved, wavy, sloping, specification regarding thickness);
Type and state of an employed sample carrier, for example a sample carrier type, preparation details, position and size of cover glasses, a tilt of the sample carrier, information on the sample substrate (for example regarding material or composition, for example glass, cycloolefins, polystyrene or membrane), thickness of the sample-carrier bottom and/or information regarding an embedding medium used (for example specification of the material, refractive index and/or Abbe number);
Type of experiment to be conducted, in particular in order to be able to deduce the structures that are relevant for the experiment, including the type of application (for example a tiles image consisting of a plurality of single, laterally offset images to be merged, or a multi-position, time-series and/or Z-stack imaging); the specification of the changing of an objective and/or a temperature or a temperature curve during an experiment is also possible;
Provided equipment of the imaging system or light microscope, for example: objective type with optional information on a correction collar and a correction-collar position for the compensation of imaging errors, information on a NA, magnification, supported wavelengths (dyes), type of immersion (in particular specification of substance such as air, water, silicone oil, glycerol, oil and/or specification of the refractive index), position of the z-piezo and/or position of the z-drive of the microscope and their interdependencies;
Ambient conditions: for example, temperature of the sample/sample environment or temperature curve over the course of an experiment, which is relevant for focus drift.

The experiment-specific information can stem from various sources. For example, the provided equipment of the light microscope or parts of the equipment can be queried automatically via software. Information on ambient conditions such as temperature can be obtained as a specification required of a user, or from sensors or as device settings of, for example, an incubator. Experiment-specific information can also be derived from captured microscope images. Some or all of the experiment-specific information can be extracted from (textual) information provided by a user. Possible sources are described in more detail in the following.

### Sources of Experiment-Specific Information

In principle, an experiment description or experiment-specific (contextual) information or parts thereof can stem from different sources, for example from a user, the microscope system, a workflow, from a history of previous experiments, or via an automatic determination.

A user input can in particular take the form of an active input of the information, for example in a text field, via voice input or via a software wizard. In a wizard, a user can be guided, for example, through a decision tree and, in the process, manually select required information. Additionally or alternatively, a user input can also take the form of a response to a specific follow-up question of a software relating to contextual information that has already been provided: for example, contextual information regarding an employed cell type can be available, but the application has not yet been specified; in order to determine a suitable application, the user can be asked: “Should the cells be preserved, or can the sample be bleached?” In a further example, a multiwell plate has been detected, so that for a better localization of the sample the user is asked: “Does the sample always adhere evenly?”; if the sample adheres at an angle in the z-direction, it is possible, for example, to prescribe an increase in the number of lateral reference points or to utilize the knowledge of a sloping progression for the determination of one or more focus planes to be used.

Experiment-specific contextual information that can be provided automatically by the microscopy system is particularly well-suited to be automatically added to a textual experiment description or to information derived from the same and for a conjoined further processing. For example, one or more of the following can be added automatically by the microscopy system to an input:
provided equipment of an employed microscope system (for example available components and usage) as set boundary conditions;
a state and/or age of microscope components;
measures of a state or a performance of microscope components;
log files with maintenance information on microscope components;
any available previous measurement results of an ongoing workflow, which can include, for example, a captured overview image, optionally with character recognition on the label areas; it is also possible for previous microscope settings of the same ongoing workflow to be taken into account, for example microscope settings for wells of a multiwell plate that have been analyzed thus far; and/or
a user-specific history of microscope settings used in past experiments. It is possible to use the history of the current user or the history for the current microscope system. Optionally, only a certain number of the most recent images are taken into account, for example the last three images of the same user. Alternatively or additionally, past microscope settings are given less weight as the past experiments increase in age.

It is also possible to utilize existing machine-readable information, for example an XML document with information on the sample or the experiment. It is optionally also possible to use metadata from previous or comparable images.

Receiving the experiment description can thus include an inputting of the experiment description or parts of the same by a user, for example by speaking or in text form using a computer. Receiving the experiment description or parts of the experiment description can also include a loading of one or more files in response to a command of the user (for example a voice command: “Use settings to capture an image as shown in FIG. 2 of Paper XY”) and using the content of said file(s) for the experiment description. Receiving parts of the experiment description can also include an automatic performance of a measurement, for example capturing an overview image, and using measurement data or information obtained from the same—for example text determined by OCR in the overview image—as part of the experiment description. Furthermore, receiving parts of the experiment description can include an automatic querying and use of system information of the microscopy system, for example information regarding provided microscope components or log data.

### Determining Experiment-Specific Information in Vectorized Form Based on the Experiment Description

The experiment description and the experiment-specific information it contains should be converted into a vectorized form with a rigidly defined structure so that the information can be processed correctly by the machine-learned model.

A vectorized form can be understood in the sense that data is represented by numerical values and different information is represented by different elements of the vector. For example, the information “cell type in the sample”, “dye used” and “sample carrier type” can be indicated as different elements of the vector. The information can thereby be processed in a practical manner by the machine-learned model. Particularly meaningful vectors can be generated by embedding the experiment-specific information by means of an encoder, as described in the following.

A representation or conversion of experiment-specific information into vectorized form can mean that the information is represented by a vector in a feature space or by a plurality of vectors in different vector spaces. A large language model, in particular a machine-learned encoder—for example a transformer encoder such as BERT—can be used to generate the vector. The input can be the experiment description or information derived from it, for example following a normalization of the experiment description by an LLM. The experiment description can in particular include text and/or image data, for which a multimodal encoder, for example a vision transformer, can be used for the calculation into the vectorized form. It is possible to use the entire output or part of the output of the encoder as the vectorized form of the experiment-specific information. For example, it is possible to use solely the calculated embedding of a token added to the input (referred to as a classification token or CLS token), because this token embedding contains information from the other entered tokens—that is to say, the contents of the experiment description—through self-attention blocks of an encoder. More generally, an encoder can also include self-attention blocks in a design that differs from a transformer structure. An encoder can generally be understood as a machine-learned model that maps input data to a low-dimensional space (that has a lower dimension than the input data), wherein the space is semantic, i.e. the closer points/vectors are to one another in the space, the more similar the information of the associated input data.

In principle, a vector can also be formed by a table whose columns or rows are considered different directions in a feature space; however, better results can generally be achieved by a vector representation via an embedding with a machine-learned encoder.

The experiment-specific information can be provided in full or at least in part in a free text of an experiment description, wherein the free text was optionally created by a user in natural language. The free text of the experiment description can be input into a large language model (LLM), which is instructed or designed to output experiment-specific information contained in the free text of the experiment description in vector form.

Optionally, the large language model evaluates whether the experiment-specific information in vector form is sufficient to determine the parameters of the focus strategy. In the event of a negative evaluation (that is to say, if the information is insufficient), the LLM asks the user follow-up questions in order to obtain the missing experiment-specific information needed to determine the parameters of the focus strategy. Alternatively or additionally, the LLM can ask follow-up questions to clarify the focus strategy or to clarify previous information. As part of the follow-up question, the model can specify a list of the required sample properties or, alternatively, query characteristics of the experiment or of the sample carrier from which the LLM or the machine-learned model can derive the required parameters.

If the experiment description or a part of the same is to be received from a user, a computer program can in particular provide a menu or a query dialog with, for example, drop-down lists via which a user can select predetermined options and/or can enter values via an input mask. Alternatively, the computer program can be designed as an interactive wizard and guide a user through a decision tree, wherein the user manually selects and/or inputs the required information. The obtained information can then be readily converted into a vectorized form.

### Parameters of the Coarse-Focus and Fine-Focus Strategy

The focus strategy to be generated, also referred to synonymously as the autofocus strategy, is divided into a coarse-focus strategy and a fine-focus strategy. This two-stage approach is important in order to cover as large a focus search range as possible and still find and maintain the focus during the experiment in an acceptable runtime while subjecting the sample to minimal stress.

The focus strategy not only defines how a one-off focus setting is determined. Rather, the focus strategy can also define how a focus control is continuously performed throughout an experiment. If a refocusing is necessary, the focus strategy also defines how this is carried out, for example by repeating the fine focusing or by varying the previous fine-focus strategy. The focus strategy can also specify how to proceed after unsuccessful focusing attempts, as described in more detail later on.

Parameters of the coarse-focus strategy and of the fine-focus strategy can include all necessary information pertaining to both the coarse-focus strategy and the fine-focus strategy so that these strategies can be carried out in a manner that is both automated and tailored to an experiment. The parameters include microscope settings to find a coarse focus and to subsequently refine the coarse focus via a further measurement. The parameters can also define actions in the event of errors, for example when a focusing is not possible: first reduce the analyzed z-distances and, should a focusing still not be possible, change the employed focus method. The parameters also include information that does not correspond to microscope settings per se, for example defined time intervals or points in a workflow for a checking and, where necessary, correction of a current focus.

Parameters of the coarse-focus strategy and fine-focus strategy can in particular respectively include a specification of a focus method to be employed, wherein a selection is made from at least two of the following methods:
a hardware autofocus method, also called as an active autofocus method, in which a suitable focus is determined by measuring a reflection of light off a sample carrier surface. A separate light source can be especially provided for this autofocus method, which emits, for example, in the far infrared and is not used for sample analysis.
a software autofocus method, also called a passive autofocus method or image contrast method, in which microscope images are captured at different height planes and a focus is derived from the microscope images. The microscope images can show the sample or in principle another structure on the sample carrier next to the sample. These images can constitute a Z-stack of the same lateral area and differ at least or solely in the focused height plane.
an AIM autofocus method (AIM: Angular Illumination Microscopy), in which a focusing is derived from differences between microscope images respectively captured with a different angular illumination. For the different illuminations, it is possible to use, for example, two LEDs, which are switched on successively and are located on opposite sides of an optical axis, so that the images that can be captured with the different illuminations are offset relative to each other.
a sample-carrier-edge/cover-glass-edge autofocus method, in which an edge or corner of a cover glass or sample carrier is detected in an overview image and a focus determination is subsequently carried out using the edge or corner. Alternatively, another sample boundary or edges of a text field can be used for this focus method.
a macroscopic height estimation based on at least one overview image. The overview image is evaluated in order to estimate the height at which a sample to be analyzed is located. Optionally, a sample carrier type can be identified in the overview image, wherein a respective height or bottom thickness is stored for different sample carrier types.

Parameters of the coarse-focus strategy and the fine-focus strategy can also specify an order in which two different focus methods are to be used. For example, the parameters can define that a hardware autofocus method is to be performed first, followed by a software autofocus method, or vice versa. This choice essentially depends on the experiment to be conducted and thus on the extracted experiment-specific information.

Parameters of the coarse-focus strategy and the fine-focus strategy can include all free parameters of a selected focus method. Free parameters are understood to mean that the values of these parameters must be defined individually, as which values deliver the best results depends on the experiment to be conducted.

In the case of a hardware autofocus method, the free parameters can include all or at least two or more of the following: offset, focus search range, illumination intensity (for example intensity of an LED used only for the focusing method), detector sensitivity and/or selection of one from among a plurality of z-determination algorithms. For example, different algorithms can be provided when a sample carrier type has three bottom parts/bottom surfaces or in particular when a filter insert is used in multiwells and dishes. An offset can indicate a z-difference between the z-focus of the autofocus illumination and the z-focus of the sample observation through the objective; when the offset is adjusted, i.e. when the z-focus of the autofocus illumination is adjusted, a height of the sample stage can be adjusted to the same extent so that the observed height plane is shifted by the offset. By means of this offset, the LED illumination can be focused on a boundary surface of the sample carrier or cover glass while a sharp image of another plane can be captured at the sample.

In the case of a software autofocus method, the free parameters can include at least: a position, number and spacing of z-planes to be captured, a sampling rate, an optimization criterion for an image quality (for example, sharpness, contrast, image variance or image energy) or for a focus evaluation algorithm as mentioned in the introduction and/or for a reference channel to be used, in particular a detection channel of the microscope. Optionally, the free parameters can also define an image pre-processing, for example properties of a noise reduction, smoothing, image sharpening or deconvolution.

Additionally or alternatively, parameters of the coarse-focus strategy and parameters of the fine-focus strategy can respectively specify a number and a lateral position of autofocus reference points. Reference points generally indicate areas based on which a suitable focusing is to be determined. The reference points in the coarse-focus strategy and the fine-focus strategy can differ; in particular, the coarse-focus strategy can use different reference points and reference points that are further apart than in the fine-focus strategy. It is also possible for the position and number of reference points to be selected differently as a function of the sample carrier type (for example, for slides with tissue sections or multiwell plates).

Parameters of the coarse-focus strategy and/or parameters of the fine-focus strategy can define when and with which focus method focus settings should be checked and, when necessary, corrected during an ongoing experiment. The parameters can also specify that, to check the focus, a focus determination according to the fine-focus strategy is performed first, and only if this fails is the coarse-focus strategy invoked for the focus determination.

The parameters can also define an action in the event of an error, for example when a focus cannot be found. The decision as to whether a focus (of a sufficient quality) can be found can be evaluated, for example, based on the focusing criteria already mentioned, such as image sharpness or variance.

The parameters of the coarse-focus strategy and of the fine-focus strategy can define an alteration of the coarse-focus strategy or fine-focus strategy in the event that a focus cannot be determined using the coarse-focus or fine-focus strategy, or in the event that a focus cannot be determined or can no longer be determined using an initially employed coarse-focus or fine-focus strategy. The alteration can in particular specify a modification of a focus search range, a step size, lateral reference points and/or of an autofocus method (for example, use of a hardware autofocus method instead of a software autofocus method).

### Iterative Generation of the Focus Strategy

The focus strategy can optionally be defined iteratively, to which end measurement data is captured and evaluated for an adjustment of the focus strategy. This process can be repeated a number of times.

An iterative definition can at least include that a (preliminary) focus strategy is first defined based on the experiment description before the following processes are carried out:

i. Capture of image data for verifying the focus strategy using the defined parameters of the focus strategy (initially defined by the machine-learned model).
ii. Deriving from the image data whether a modification of the defined parameters of the focus strategy should occur and, if so, which modifications should be carried out. This can occur via user feedback on the image data and/or via image analysis.
iii. Initiating a planned experiment using the focus strategy in cases where a modification of the defined parameters of the focus strategy is not required; or proceeding with i. with modified parameters of the focus strategy in cases where a modification of the defined parameters of the focus strategy is deemed necessary.

### Checking and Adjusting the Focus Strategy

During the performance of an experiment with the defined autofocus strategy or during data capture with an (active) autofocus strategy, a checking and, where necessary, adjustment of the focus strategy can be carried out. For the checking of the focus strategy, in particular an image quality can be evaluated and/or a number of previous successful and/or failed autofocus attempts can be taken into account. It is also possible to take into account a position of found focus positions in relation to predetermined boundaries for the evaluation of whether an adjustment of the focus strategy should occur.

An adjustment of the focus strategy can be provided in the event that, based on measurement data captured during the experiment up to that point, a height variation of the sample is detected, i.e. in the event that a sample or sample layer to be analyzed varies more in the height direction than was assumed when the focus strategy was defined. This can be the case, for example, with retinal samples. A modification of the focus strategy, including an increasing of the number of lateral reference points and/or of the focus search range, can occur during an ongoing experiment.

During a data capture using the focus strategy, a checking and, where necessary, adjustment of the focus strategy can also include the following processes: Based on captured image data, it is evaluated whether a focusing is still possible if one or more image channels and/or focus methods are omitted. In the affirmative, one or more image channels and/or focus methods are accordingly omitted. This renders possible an adaptive decision as to whether a high focus quality is already achieved with less measurement data, which can save time and reduce the stress to which the sample is subjected. In addition to an omission of image channels and focus methods to be used, it is also possible to reduce the focus search range or to increase a z-step size to cover the focus search range.

A modification of the focus strategy can also involve the use of modes (for example illumination or detection channels), for example when it is not possible to capture an image deemed to have a sufficient quality or when the sample has adopted a different focus position due to growth or movement.

Adjustment of the Focus Strategy with Sensor Data

During an ongoing experiment conducted using the defined focus strategy, ambient characteristics can be repetitively or continuously monitored by means of at least one sensor and utilized for an adjustment of the focus strategy. One or more sensors can, for example, measure the ambient temperature or sample temperature, which can influence the z-focus drift. Measurements of the at least one sensor or a time series of measurements of the sensor can be used together with the (remaining) experiment-specific information in vectorized form as input into the machine-learned model for a continuous correction of the parameters of the focus strategy. The measurements or the time series of measurements of the sensor can also be used for the initial definition of the parameters of the focus strategy. The smaller the temperature changes are over time, the less frequently the focus strategy can provide, for example, a focus control (for example by means of a software-based autofocus method).

It is analogously also possible to use image data, for example sample images or overview images, for a continuous control and adjustment of the focus strategy. The focus strategy should be adjusted, for example, when a change is established in continuously captured overview images that affects the focus position. Examples of such a change could be, for example, a change in a quantity or color of a sample medium or immersion medium, a formation of condensation or droplets in the beam path, or a formation of gas bubbles in a sample liquid.

### Machine-Learned Model

The derivation of the focus strategy from the experiment-specific information is carried out using a machine-learned model. The model can have been trained using supervised machine learning. The model calculates a mapping from the vectorized (contextual) information to parameter settings for the focus strategy. It is possible for all required parameters of the focus strategy to be calculated by the model, or at least a plurality of the required parameters while other parameters are determined in some other manner, for example using a database described in more detail later on.

The model can include a plurality of individual models/submodels that are trained separately or together. A submodel calculates values for specific required parameters of the focus strategy.

For example, the machine-learned model can include a plurality of submodels learned by supervised learning, wherein one of the submodels calculates at least one selection or exclusively a selection of the focus method for the coarse-focus strategy. Another submodel calculates at least one selection or exclusively a selection of the focus method for the fine-focus strategy. Optionally, a further submodel in turn determines a number and/or position of focus reference points (lateral xy coordinates of points or regions at which a suitable focus setting should be determined). In principle, an individual model can be trained for each parameter, for example also for the laser power, a focus search range, or time intervals until a focus control. Individual/submodels can make it easier to track which model component is responsible for a specific parameter of the focus strategy, which facilitates adjustments of the model as well as a follow-up training or correction the model.

Instead of individual models, it is also possible to use a complete model with all inputs and outputs. Two complete models are also possible, wherein one determines all the necessary parameters for the coarse focusing and the other determines all the necessary parameters for the fine focusing. Any combination or blend of the described models is possible. Complete models can be advantageous in that only compatible combinations of parameter settings are output. In the case of individual models, this can be achieved by using an output from one individual model together with the experiment-specific information as input for another individual model.

With individual models, not every prediction dimension is necessarily required. For example, no parameter values are required for a hardware autofocus method if a software autofocus method is defined as the focus method. The parameter values that are not required can be discarded or not predicted in the first place.

Analogously, not all available experiment-specific information is required depending on the autofocus method, i.e. for the calculation of certain parameter settings. For example, the experiment-specific information “cover glass thickness” is required for different hardware autofocus methods, but not for software autofocus methods. If a submodel first determines the autofocus method, which experiment-specific information is input into subsequent submodels is selected as a function of this determination.

### Outputs of the Machine-Learned Model

Outputs of the machine-learned model can in particular take the form of vectors of discrete or continuous values, or of an output image. It is also possible for an output image to have discrete values (for example in the case of a segmentation) or continuous values (for example in the case of density or probability maps). An output image can be, for example, a segmentation of focus reference points. In the case of an output image with continuous values, pixel values can indicate, for example, a suitability as a focus reference point.

For the prediction of complete or individual models, the following tasks, for example, can be automated:
Classification: A classification can be used, for example, to select an autofocus method or a channel to be used.
Regression: A laser power for the autofocus, for example, can be defined by regression.
Segmentation: For example, regions that are suitable as focus reference points can be determined by means of a segmentation.
Detection: For instance, the locations that are suitable as focus reference points can also be determined by means of a detection.
Image-to-image transformation, for example in the case of the output of an image whose pixel values indicate a suitability as focus reference points. The input in this case includes an image of the sample or sample area, and the output image is co-registered to this image, i.e. pixels/location coordinates in the output image can be transferred to the input image in order to determine, for example, the coordinates of the focus reference points.

### Database for Deriving Parameter Values of the Focus Strategy

Individual tasks, for example the classification of a method selection or a regression to a parameter value, can also be implemented using lookup tables or by means of heuristics. As an example of a heuristic, in a case where a visibility of tissue has already been established in an overview image of an overview camera, a reference channel for a software autofocus can be set to wide field, as this bleaches the sample less.

At least some of the parameters of the focus strategy can be determined with the aid of a database in which it is stored for experiment-specific information in vectorized form which parameter values of the focus strategy are to be used. Such a database can optionally be used to determine those parameter values that are not calculated by the machine-learned model described above. Alternatively, the database and the model can also be used to determine values, at least in part, for the same parameter. An average value of the determined values can then be used or, alternatively, one of the two parameter values is only used in the event of an error that a focus cannot be found with the parameter value that was used first.

Experiment descriptions are not stored in the databank, but rather the experiment-specific information in vectorized form respectively extracted from an experiment description. These are also referred to in the following as embeddings, as they were calculated from the experiment descriptions by means of a mapping into a feature space or embedding space.

For the purposes of linguistic differentiation, the experiment-specific information in vectorized form calculated from the experiment description for a new planned experiment is referred to as the embedding vector in the following.

Parameters of focus strategies of previous successful experiments can be used to derive parameters of the focus strategy for a new experiment. For an embedding vector, embeddings of similar microscope experiments are ascertained in the embedding space based on the distance between them in the embedding space. Suitable values of parameters of the focus strategy are stored in the database for each experiment. Parameter values for the new experiment are defined based on the parameter values stored in the database for one or more of the most similar microscope experiments that are found.

Optionally, to derive parameter values from the embedding vector, it can be determined using the database which stored embedding in the database is at a minimum distance in the feature space from the embedding vector. The parameter values are then defined at least based on the parameter values of the stored embedding with the smallest distance from the embedding vector. For example, the parameter values of the stored embedding with the minimum distance can be used as parameter values for the new experiment.

Different distance measures can be used to determine a distance in the feature space such as, for example, the L1 distance (Manhattan distance) or L2 distance (Euclidean distance). More complex distance measures are also possible. For example, it is possible to determine for which embeddings or regions in the feature space a uniform value of a given parameter (e.g. specification of the autofocus method) is available, whereupon regional boundaries are defined in the feature space (for example so that different defined regions in the feature space represent different autofocus methods). Crossing a regional boundary registers as a penalty point or an increase in distance. A given Euclidean distance between two points in the feature space thus varies in magnitude depending on whether the two points are in the same region or in different regions of the feature space.

It is also possible to select a plurality of stored embeddings for the derivation of parameter values. The selection is made according to the proximity of the embeddings to the embedding vector in the feature space, i.e. the selection includes the embedding that is the shortest distance away, the embedding at the second shortest distance away, etc. The selection can be made similarly to k-nearest neighbor methods. The definition of the microscope settings now occurs based on the microscope settings of the selected plurality of stored embeddings. Optionally, a number of the plurality of stored embeddings to be selected can be predetermined so that, for example, the three closest embeddings are always used. Alternatively, it is possible to select each stored embedding within a predefined radius around the embedding vector, whereby the number of embeddings used is variable. In a further variant, a further embedding continues to be selected until a ratio of a distance between a last selected embedding and a further embedding exceeds a predetermined threshold value. This essentially selects all embeddings from a same cluster, while embeddings that are further away from this group of embeddings are not used.

To derive parameter values from the embedding vector using the database, it is alternatively or additionally possible to provide: The embeddings in the feature space are clustered and a cluster associated with the embedding vector is determined. Clustering can be understood as assigning points that lie close to one another in the feature space to the same group (cluster). This divides the feature space into different clusters. The embeddings from the cluster in which the embedding vector is located are selected. Parameter values are then derived from the parameter values of the selected embeddings, i.e. the embeddings of the cluster associated with the embedding vector. It is also possible to use another embedding method, for example a (t-distributed) stochastic neighbor embedding (t-SNE), to cluster points in the feature space.

In a variant, it is possible for all existing embeddings of known experiments in the embedding space to be clustered, for example by t-SNE, and to subsequently receive a cluster ID. Depending on its position in the feature space or its proximity to embeddings of known experiments, an embedding vector is then assigned all embeddings with a given cluster ID. Thus, instead of selecting a single embedding, all embeddings of a cluster are selected in order to derive parameter values.

For parameters with continuous value ranges, the parameter values of a plurality of selected embeddings can be interpolated or combined with one another, for example through a weighted averaging. The weighting occurs as a function of the distance in the feature space between the embedding vector and a respective embedding, so that the weighting becomes weaker with increasing distance. It can be respectively stored in the database for different parameters whether they have a continuous value range, i.e. whether they can be averaged or interpolated. One parameter that cannot be interpolated is, for example, the autofocus method used. On the other hand, microscope settings with continuous value ranges include, for example, a measurement or illumination duration or a z-step size for the focus determination.

### Continuous Learning of the Calculation of the Parameters of the Focus Strategy

After an in particular successful implementation of the autofocus and/or due to a user interaction with the focus, training data can be collected for a follow-up training of the machine-learned model or for an expansion of the database.

In particular after a data capture using the focus strategy, a test can be carried out to determine whether the focus strategy or an experiment conducted with the same was successful, for example by determining a sharpness measure for captured images. In the case of a successful test result, parameters of the employed focus strategy and associated experiment-specific information in vectorized form are added to training data for the machine-learned model or to the aforementioned database.

Alternatively or additionally, in cases where a user modifies calculated parameters of the focus strategy and conducts an experiment with said modified parameters, it can be provided that the training data of the machine-learned model or the database is augmented by the parameters of the employed focus strategy that have been modified by the user as well as associated experiment-specific information in vectorized form.

Optionally, it is also possible to provide defaults as a function of the user, wherein it is monitored whether a user makes modifications or with which modifications a user carries out the experiment, which renders possible a user-dependent learning.

In addition to the parameters in cases of a successful autofocusing, it is also possible to collect the parameters and underlying experiment-specific information that were unsuccessful or rejected by a user. These negative examples can also be taken into account for a training or for the database.

### General Features

A microscope image can be understood as an image that is captured by a microscope or that is calculated using measurement data of a microscope. The microscope image can in particular be formed by one or more raw images or further processed images of the microscope and can include 2D image data or a 3D image stack or volumetric data, or alternatively time-series data in which 2D or 3D image data of the same object was captured at different points in time.

In principle, microscope images can depict any structure or object. In addition to the sample itself, for example biological structures, electronic elements or rock fragments, it is also possible for a sample vessel, a sample carrier, or a microscope component such as a sample stage or areas of the same to be depicted.

The microscope can be a light microscope with a system camera and, optionally, a separate overview camera. The overview camera or its objective is optionally non-telecentric. Other types of microscopes are also possible, for example electron microscopes, X-ray microscopes or atomic force microscopes. A microscopy system refers to a device that includes at least one computing device and one microscope.

The computing device can be designed in a decentralized manner, can be physically part of the microscope, or can be arranged separately in the vicinity of the microscope or at a location at any distance from the microscope. It can generally be formed by any combination of electronics and software and can in particular include a computer, a server, a cloud-based computing system or one or more microprocessors or graphics processors. The computing device can also be configured to control microscope components.

In the context of the present invention, an annotation is understood to be a predetermined result that is ideally calculated by a model in a supervised training from an input associated with the annotation. The deviation between the model output and the annotation is used in the training to adjust the model parameters/weights. Depending on the model, an annotation can be an image, can include image data or a segmentation mask, or can be formed by other data, for example numerical values or classifications by object type or size. In contrast to an annotation, a piece of contextual information refers to data that is input into the model as part of the input data for the calculation of the model output.

Formulations such as “based on”, “using”, “depending on” or “as a function of” are not to be understood as exhaustive, so that further dependencies can exist. Descriptions in the singular are intended to cover the variants “exactly 1” as well as “at least one”.

The characteristics of the invention that have been described as additional apparatus features also yield, when implemented as intended, variants of the method according to the invention. Conversely, the microscopy system or in particular the computing device and/or the computer program can be configured to execute the described method variants. Described training processes of a machine-learned model define characteristics of the ready-trained model, wherein different method variants are defined so that either the described training processes constitute method steps of a method according to the invention that are to be carried out or, alternatively, an accordingly trained model is used in the inference phase.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 is a schematic depiction of processes of an example embodiment of the invention;

FIG. 2 is a schematic depiction of processes of a further example embodiment of the invention;

FIG. 3 is a schematic depiction of processes of a further example embodiment of the invention;

FIG. 4 is a schematic depiction of processes of a further example embodiment of the invention; and

FIG. 5 schematically shows an example embodiment of a microscopy system according to the invention.

### DETAILED DESCRIPTION OF EXAMPLE EMBODIMENTS

Different example embodiments are described in the following with reference to the figures.

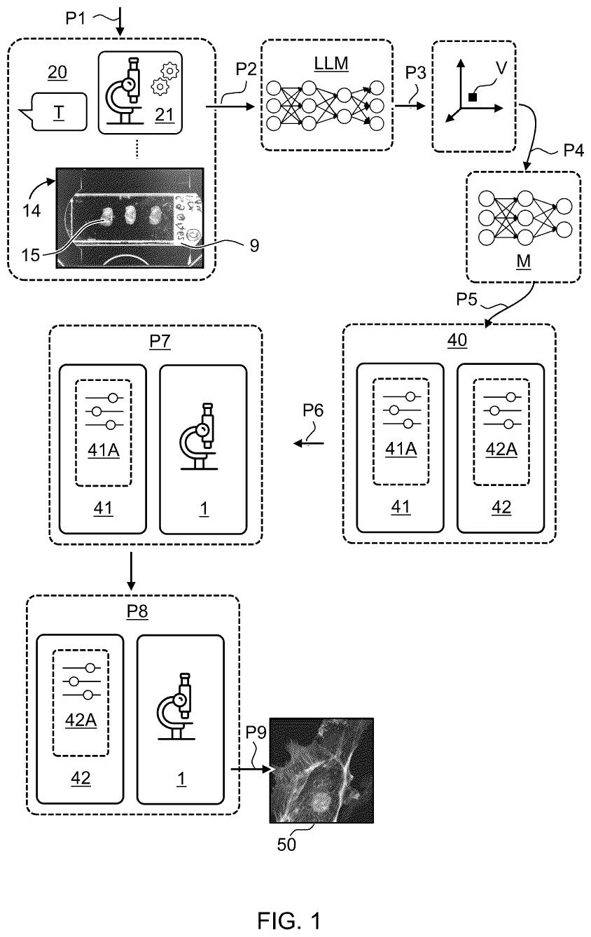

### FIG. 1: Determining a Focus Strategy Based on an Experiment Description

FIG. 1 schematically shows processes of an example embodiment of a computer-implemented method according to the invention for automatically focusing a light microscope.

First, in process P1, an experiment description 20 is received, which includes at least one textual description T relating to a planned sample analysis. The textual description T can be written by a user in natural language and input in text form or via voice input. An example of a textual description T of the experiment is: “Hela cells are analyzed by fluorescence imaging with DAPI and Alexa 488 dyes; the focus is on image quality; a strong bleaching of the samples is permitted”.

In addition to the textual description T, the experiment description 20 can also contain further experiment-specific information (contextual information). In the example shown, the experiment description 20 includes automatically ascertained microscopy system data 21, for example relating to the provided equipment of the employed microscopy system, a state of the available microscopy components and log files with maintenance information regarding the microscopy components. Optionally, as in the example shown, the experiment description 20 includes image data, in particular a macroscopic overview image 14 in which a sample carrier 9 with a sample 15 is visible.

The experiment description 20 is input into a learned model in process P2, in the illustrated case into a large language model LLM, which calculates experiment-specific information in vectorized form V from the experiment description 20 in process P3. The experiment-specific information can include, inter alia, information on a type and state of the sample and sample carrier as well as a visibility and coordinates of the sample visible in the overview image and of the sample carrier. The LLM can contain, for example, a transformer encoder whose output includes the vectorized form V.

In process P4, the experiment-specific information in vectorized form V is input into a machine-learned model M. The model M is designed to calculate a mapping from the input to values or settings of parameters 41A, 42A of a focus strategy 40, process P5. The focus strategy 40 includes a coarse-focus strategy 41 and a fine-focus strategy 42, both of which are defined by the parameters 41A, 42A. The parameters 41A, 42A specify, inter alia, which of a plurality of possible focus methods are used for the coarse focusing and the fine focusing, and with which settings.

The machine-learned model M can have been learned in a supervised manner using training data, wherein the training data includes an experiment description or experiment-specific information in vectorized form as input data and an associated annotation, which the model output should ideally match. Parameters of focus strategies gathered, for example, by observing users are used as annotations. A focus strategy selected by a user that has proven to be successful can thus be registered and used for the training data. Focus strategies that were first tested by a user before being rejected can also be taken into account in the training as negative examples.

Using the focus strategy 40 with the determined parameters 41A, 42A, a data capture with the microscope 1 is initiated and monitored in process P6.

A coarse focusing can be carried out first in process P7, for which the parameters 41A of the coarse-focus strategy 41 are used.

After a successful coarse focusing, a fine focusing according to the fine-focus strategy 42, as defined by the parameters 42A, is carried out in process P8.

If the fine focusing is carried out successfully, the experiment is conducted in process P9, wherein at least one microscope image 50 is captured.

The focus strategy 40 can also provide that one or more coarse and/or fine focusings are carried out during the experiment, for example to compensate for a focus drift or in order to focus on different height planes to be analyzed.

The parameters 41A and 42A can cover all settings necessary for the coarse-focus and fine-focus strategies 41, 42, so that it is no longer necessary for a user to specify settings manually.

In particular, the parameters 41A and 42A for the coarse-focus and fine-focus strategies 41, 42 respectively specify which of a plurality of possible focus methods is to be used. The machine-learned model M was trained to respectively select a focus method from a plurality of different focus methods for the coarse-focus and fine-focus strategies 41, 42. In principle, it is also possible for the same focus method (but with different settings, for example focus search range, step size and reference points) to be used for the coarse-focus strategy 41 and the fine-focus strategy 42. Possible focus methods include, for example, a hardware or software autofocus method, an AIM autofocus method, a sample-carrier-edge/cover-glass-edge autofocus method or a height estimate based on the overview image 14, as was explained in more detail in the general part of the description.

The parameters 41A and 42A also specify concrete values or settings for the selected focus method(s). In addition to a focus search range, a z-step size and lateral coordinates of focus reference points, these can include a laser power in the case of hardware autofocus methods and/or a selection of an algorithm for evaluating which of a plurality of images corresponds to a best focus in the case of software autofocus methods. Further examples are given in the general part of the description.

If an experiment description with a textual description, in particular of the sample, and an overview image are used together, significantly more information can be utilized than in conventional approaches, whereby more precise specifications of a suitable focus strategy become possible. If, for example, merely a sample dye is determined from an overview image, it would be virtually impossible to set all the parameters of a focus strategy in an ideal manner. In contrast, the textual description of the planned sample analysis and the overview image can provide a wealth of information that is relevant for determining the focus strategy, e.g.:
If a user desires a sample-preserving analysis, for example one without bleaching, the coarse focusing is preferably carried out outside the sample area, for example using a sample-carrier-edge/cover-glass-edge autofocus method, a height estimation based on the overview image, or by means of a hardware autofocus method laterally outside the sample area.
If, in spite of a desired sample-preserving analysis, a coarse-focus strategy with an active illumination of the sample area is defined, the illumination intensity is reduced to protect the sample. Only if an insufficient illumination makes a coarse focusing impossible is the illumination intensity increased or another autofocus method used. To protect the sample, it is also possible to increase the z-step size or to analyze fewer height planes in a software autofocus method, additional measurements for a smaller z-step size only being added in the event that a focusing is not possible.
If a sample with a sufficient contrast is deduced from the overview image and/or sample description, a coarse focusing can potentially be performed in the sample area using a software autofocus method, unless, for example, sample preservation considerations dictate otherwise. If, on the other hand, it is inferred from the overview image and/or the textual sample description that a coarse focusing in the sample area would be too complicated due to, for example, a low contrast, a coarse focusing in the sample area using a software autofocus method is rejected.
If a sample with a variable height or sloping arrangement (relative to the height direction/optical axis) is inferred from the overview image and/or the sample description (for example in the case of tissue samples that do not adhere evenly to the bottom of a sample vessel), a number of lateral reference points for a focus determination is increased, at least for a fine focusing on the sample, and optionally for a coarse focusing if performed in the sample area.
If a user wants results as quickly as possible and a potential sample bleaching is not a problem (either because a user has specified that a bleaching is acceptable or because contextual information on the sample suggests that sample damage due to stronger illumination is unlikely), it is possible to increase the illumination intensity for the coarse and/or fine focusing and to select a coarse focusing in the sample area and/or an autofocus method that works faster than other autofocus methods but with a higher stress level for the sample.

It is thus possible to automatically define an ideal focus strategy that is tailored to the provided sample, the planned experiment and the desires of a user regarding, for example, a sample preservation.

The performance of the coarse focusing and the fine focusing in processes P7 and P8 can be regarded as preparation for or as part of the conducting of an experiment. Processes P7 and/or P8 can be repeated during the experiment in order to, for example, focus on different height planes to be analyzed or to compensate for a focus drift.

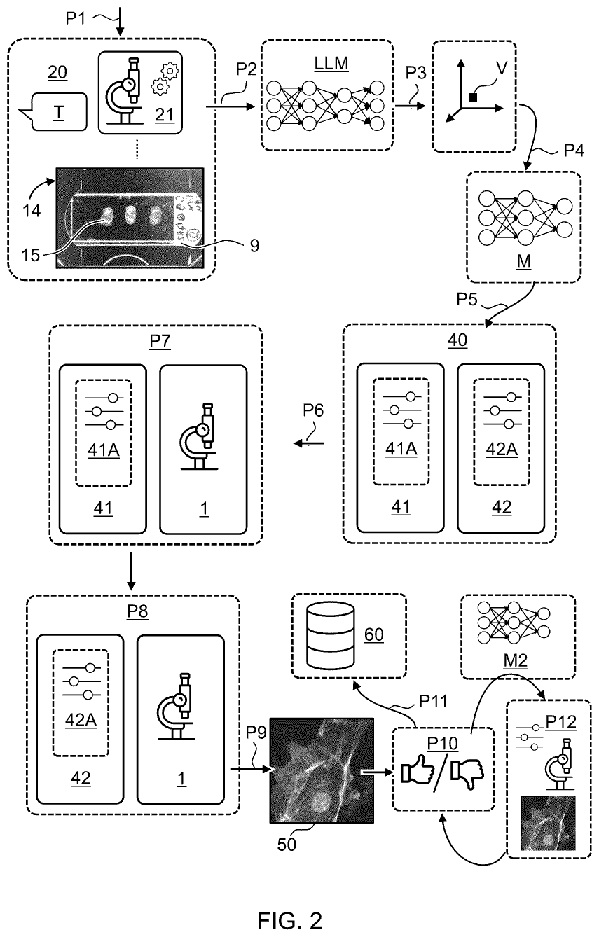

### FIG. 2: Focus Evaluation and Follow-Up Actions

The example embodiment of FIG. 1 can be supplemented by further processes, such as those shown by way of example in FIG. 2.

As described in connection with the previous figure, an experiment was carried out with the calculated focus strategy 40 in process P9, during which microscope images 50 were captured. The microscope images 50 are subsequently evaluated in process P10, in particular with regard to an image quality, focus or visibility of desired structures. Which structures are to be sought automatically, for example by detection, classification or segmentation, can be derived automatically by the LLM from the experiment description 20, so that a suitable machine-learned checking model is selected in process P10.

If the microscope images 50 are evaluated positively in process P10, the employed focus strategy 40 is considered successful. The focus strategy 40 is thus incorporated in training data 60 together with the associated experiment-specific information in vectorized form V (or the associated experiment description 20). The training data 60 can thus be used to carry out a follow-up training or re-training of the machine-learned model M, so that model improvements are possible through observation and evaluation of microscopy experiments.

If the microscope images 50 are evaluated negatively in process P10, an adjustment of the currently defined values of the parameters 41A, 42A of the focus strategy 40 is carried out by means of a further model M2. The experiment or a data capture is then repeated in process P12, and the described evaluation is subsequently repeated in process P10. The model M2 can be machine-learned and can differ from the machine-learned model M, although it is alternatively possible for it to be the same model. If it is the same model, it can be designed, for example, to receive, in addition to the experiment-specific information in vectorized form V, an evaluation result from process P10 or a vector calculated from the same as contextual information. This contextual information can indicate, for example, that sharp images were captured for some lateral areas, but not for other lateral areas of the sample. The model can then provide additional lateral reference points for a coarse and/or fine focusing, in particular in or next to the lateral areas of the sample for which it was not possible to capture sufficiently sharp images. In an alternative design, the model M2 can also be part of the LLM and receive the contextual information from process P10 as additional input in order to output correspondingly adjusted experiment-specific information in vectorized form V. This adjusted information can in turn be processed by the machine-learned model M to obtain parameters for an adjusted focus strategy.

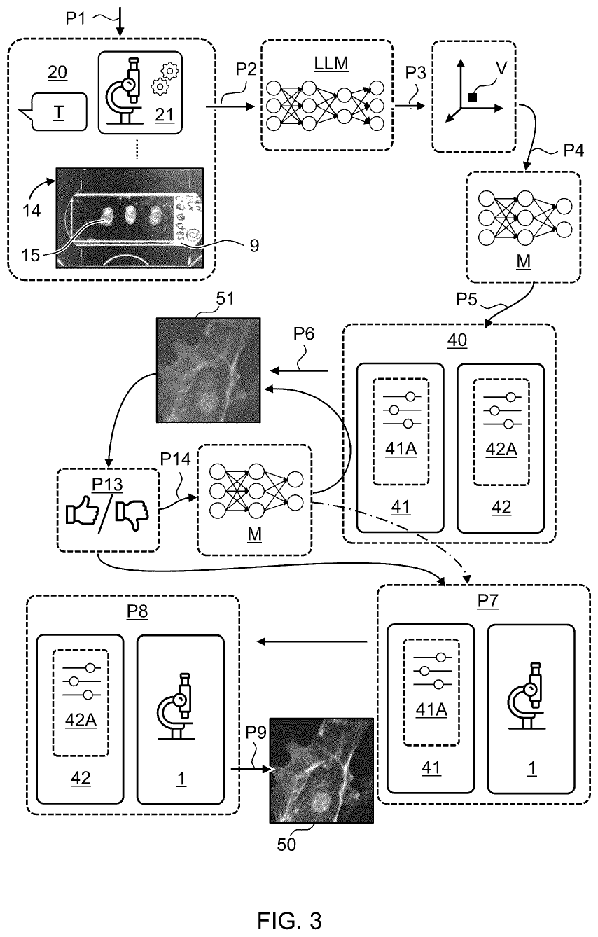

### FIG. 3: Iterative Generation of the Focus Strategy

Processes of a variant of the example embodiments shown in the preceding figures are shown schematically in FIG. 3.

In this case, there occurs an iterative generation of the focus strategy 40, to which end either the machine-learned model M does not initially calculate all the parameters 41A, 42A of the focus strategy 40 in process P5 or the initially calculated parameters 41A, 42A are considered provisional and continue to be refined, where necessary.

Using the currently defined parameters 41A, 42A of the focus strategy 40, a data capture is first carried out in process P6 in order to capture one or more test images 51. In process P13, the test images 51 are evaluated or used to verify the focus strategy 40. If no problems are found in process P13, the experiment is initiated using the coarse-focus strategy and the fine-focus strategy, as described in relation to the previous figures. If, on the other hand, an evaluation of the test images 51 in process P13 yields a negative result, the currently defined parameters 41A, 42A are modified in process P14. New test images 51 can then be captured and evaluated in process P13. Alternatively, the experiment can be conducted with the coarse and fine focusing directly with the modified parameters 41A, 42A in processes P7-P9 (see dashed-dotted line).

Modifications of the currently defined parameters 41A and 42A of the focus strategy 40 can be determined, for instance, using the machine-learned model M or using a separately trained model or even using a classic algorithm without the use of machine learning. For example, a long-term experiment can be planned in which images of different lateral areas of a sample are repeatedly captured. Test images 51 can accordingly show the different lateral areas to this end. If it is evaluated in process P13 that a fine focusing is possible for some but not all test images 51 captured for different lateral areas, and it is known that the sample has a varying height (for example in the case of retinal samples), then in process P14 the number of lateral reference points can be increased and/or the z-step size can be refined or the z focus search range can be increased for the problematic lateral areas.

In a further example, the test images 51 are used to select an algorithm and/or an image pre-processing for the focus evaluation of a software-based autofocus method. For example, depending on image properties such as noise, sharpness or variance and depending on image content (e.g., imaged cell type), one of a plurality of possible algorithms can be selected which evaluate a focusing based on, for example, either image sharpness or variance or summed pixel energy. A pre-processing, for example an image smoothing, can also have a significant influence on the precision of the algorithm, so that the pre-processing is also selected as a function of the test images 51. In this example, certain parameters of the focus strategy, namely for the algorithm and the pre-processing, were not yet set in process P5, but only after capture of the test images 51.

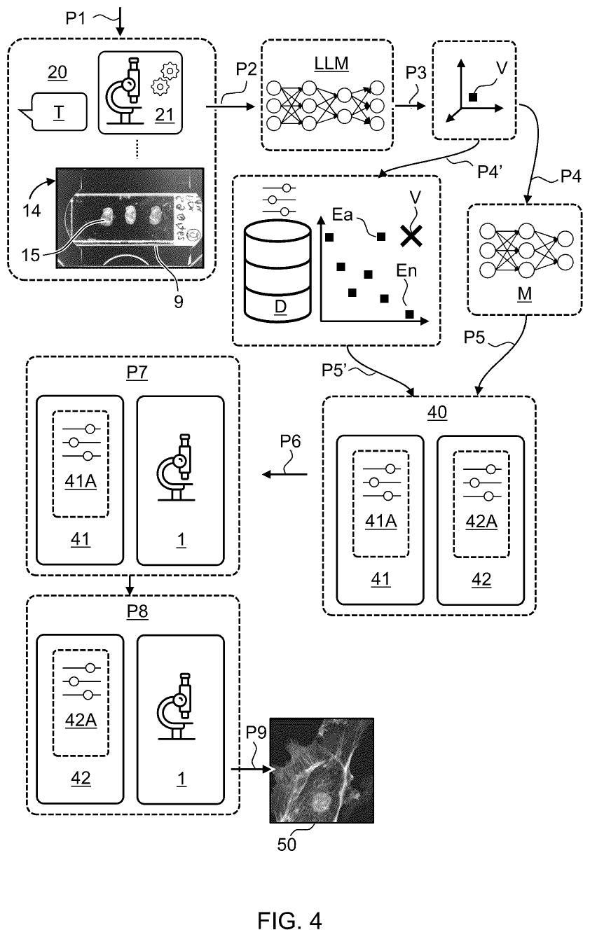

FIG. 4: Database with Experiment-Description Embedding Vectors and Focusing Parameters

The preceding example embodiments can be supplemented by additional processes such as those shown schematically in FIG. 4. In this example, values or settings of parameters 41A, 42A of the focus strategy 40 are not calculated from the experiment-specific information in vectorized form V, process P5, by a machine-learned model alone.

Instead, a database D is also used, in which a set of suitable parameter values for a focus strategy is respectively stored for different sets of experiment-specific information in vectorized form (embeddings) Ea to En. Thus, for each set of experiment-specific information in vectorized form, an associated set of parameter values for a suitable focus strategy is stored. Experiment descriptions 20 (for example in natural language or with image data) are not stored in the database D, but rather the embeddings calculated from experiment descriptions (experiment-specific information in vectorized form), as can be calculated, for example, by a transformer encoder as part of the LLM. These embeddings are calculated in the same way as the experiment-specific information in vectorized form V in process P3. The embeddings Ea to En stored in the database D and the experiment-specific information in vectorized form V calculated in process P3 from the current experiment description are thus vectors in the same feature space/embedding space. This feature space is semantic, so that points close to each other describe similar experiments for which a similar focus strategy is likely to be suitable.

In process P4′, the experiment-specific information in vectorized form V is compared with the embeddings Ea to En stored in the database D, and the embedding that is the shortest distance away is determined, in this example the embedding Ea. The values of parameters 41A and 42A of the focus strategy stored in the database for this embedding Ea are selected in process P5′ for the current experiment. Instead of just the closest embedding Ea in the feature space, it is also possible to select a plurality of the closest embeddings and to average the parameter values stored in the database D for these embeddings, optionally weighted according to the distance from the vector of the experiment-specific information in vectorized form V.

The parameters 41A and 42A determined using the database D in process P5′ and the parameters 41A and 42A determined using the machine-learned model M in process P5 can complement each other, so that only together do they form a complete set of required parameters for the focus strategy 40. For example, the database D can be used to select the focus method(s), while the machine-learned model M is used to determine the number and positions of lateral reference points for the focusing.

In a variant of the shown embodiment, the database D and the machine-learned model M are not used in parallel to determine the values of the parameters 41A and 42A, but rather sequentially. In this case, the initially determined values of parameters are taken into account for the subsequent sequential determination. For example, a parameter can first be calculated from the experiment-specific information in vectorized form V using the database D, wherein the parameter in question specifies a selection of an autofocus method, for example a software autofocus method. Subsequently, both the experiment-specific information in vectorized form V and the parameter defined using the database (here: selection of a software autofocus method) are input into the machine-learned model M. The machine-learned model M calculates values of the remaining required parameters from these inputs, including the values for step size and focus search range required for the software autofocus method.

The described database D in particular offers the advantage that a subsequent incorporation of new data is readily possible without a retraining of the model. In particular, the data described as training data 60 in connection with FIG. 2 can also be incorporated in the database D without requiring a retraining of the model.

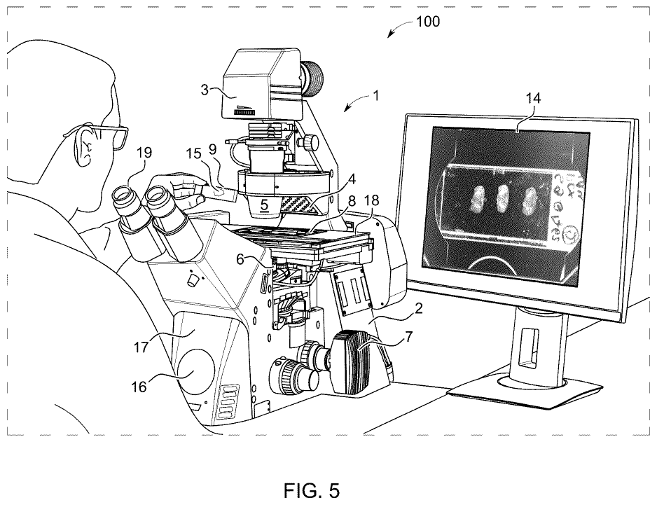

### FIG. 5: Microscope

FIG. 5 shows an example embodiment of a microscope system 100 according to the invention. The microscope system 100 includes a microscope 1 and a computing device 17, which can be part of the microscope 1 or separate from the microscope 1. The microscope 1 includes a stand 2 via which further microscope components are supported. The latter can in particular include: an illumination device 3; a condenser 5 for guiding illumination light to a sample area; an objective changer or revolver, on which an objective 6 is mounted in the illustrated example; a sample stage 18 with a holding frame 8 for holding a sample carrier 9; and a microscope camera 7. When the objective 6 is pivoted into the light path of the microscope, the microscope camera 7 receives detection light from a sample area in which a sample 15 can be located in order to capture a microscope image. In principle, a sample 15 can be or can include any object, fluid or structure. To capture a microscope image that can serve as an overview image 14 of a sample environment, the microscope 1 can use an objective with a lower magnification and/or an optional additional overview camera (not illustrated), which views the sample area from a perpendicular or an oblique angle. For the capture of an overview image, an illumination can be used that includes, for example, a plurality of LEDs 4 whose illumination direction for a dark-field measurement is oriented obliquely to a detection axis. In addition to the microscope camera 7, a sample can also be observed through an eyepiece 19. The microscopy system 100 also includes a computer program 16, depicted only schematically, which is stored on a non-volatile data memory. The computer program 16 or the computing device 17 is configured to execute the method variants described in connection with the other figures. In the illustrated example, the microscope 1 is a light microscope, but in principle it can also be another type of microscope.

The variants described in relation to the different figures can be combined with one another. The described example embodiments are purely illustrative and variants of the same are possible within the scope of the attached claims.

### LIST OF REFERENCE SIGNS

1 Microscope
2 Stand
3 Illumination device
4 LEDs
5 Condenser
6 Objective
7 Microscope camera/system camera
8 Support frame for holding a sample carrier
9 Sample carrier
14 Microscope image/overview image
15 Sample
16 Computer program
17 Computing device
18 Sample stage
19 Eyepiece
20 Experiment description
21 Microscopy system data
40 Focus strategy
41A, 42A Parameters of a focus strategy
41 Coarse-focus strategy
42 Fine-focus strategy
50 Microscope image
51 Test image(s)
60 Training data for a follow-up training/retraining of the machine-learned model M
100 Microscopy system
D Database with embeddings Ea-En for experiment descriptions and respectively associated parameters for a focus strategy
Ea-En Embeddings stored in the database D
LLM Language model/Large language model
M Machine-learned model
M2 Model for adjusting the currently defined values of the parameters of the focus strategy
P1-P14 Processes of methods according to the invention
T Textual description as part of the experiment description
V Experiment-specific information in vectorized form

What is claimed is:

1. A computer-implemented method for automatically focusing a light microscope, including:
receiving an experiment description including at least one textual description pertaining to a planned sample analysis;
determining experiment-specific information in vectorized form based on the experiment description;
inputting the experiment-specific information in vectorized form into a machine-learned model for defining parameters of a focus strategy that includes a coarse-focus strategy and a fine-focus strategy; and
initiating and monitoring a data capture with the light microscope using the focus strategy.

2. The method according to claim 1,
wherein the experiment-specific information in vectorized form used to define the parameters of the focus strategy includes:
a type and state of the sample;
a type and state of an employed sample carrier;
a type of an experiment to be conducted;
provided equipment of the light microscope and a temperature of the sample or a sample environment.

3. The method according to claim 1,
wherein the experiment-specific information is provided at least in part in a free text of an experiment description;
wherein the method also includes: inputting the free text of the experiment description into a large language model, which is instructed or designed to output experiment-specific information contained in the free text of the experiment description in vector form.

4. The method according to claim 3,
wherein the large language model evaluates whether the experiment-specific information in vector form is sufficient to determine the parameters of the focus strategy,
wherein, in the event of a negative evaluation, the large language model asks a user follow-up questions in order to obtain missing experiment-specific information needed to determine the parameters of the focus strategy.

5. The method according to claim 1,
wherein parameters of the coarse-focus strategy and fine-focus strategy respectively include a specification of a focus method to be employed, wherein a selection is made from at least two of the following methods:
a hardware autofocus method with a measurement of a reflection of light off a sample carrier surface;
a software autofocus method in which microscope images are captured at different height planes and a focus is derived from the microscope images;
an angular illumination microscopy, AIM, autofocus method in which a focusing is derived from differences between microscope images respectively captured with a different angular illumination;
a sample-carrier-edge/cover-glass-edge autofocus method, in which an edge of a cover glass or sample carrier is detected in an overview image and a focus determination is subsequently carried out using the edge; and
a macroscopic height estimation based on at least one overview image.

6. The method according to claim 1,
wherein parameters of the coarse-focus strategy and the fine-focus strategy specify an order in which two different focus methods are to be used.

7. The method according to claim 1,
wherein parameters of the coarse-focus strategy and the fine-focus strategy include all free parameters of a selected focus method,
wherein, in the case of a hardware autofocus method, the free parameters include two or more of the following: offset, focus search range, illumination intensity, detector sensitivity, selection of one from among a plurality of z-determination algorithms;
wherein, in the case of a software autofocus method, the free parameters include at least: a position, number and spacing of z-planes to be captured, a sampling rate, an optimization criterion for an image quality and a reference channel to be used.

8. The method according to claim 1,
wherein parameters of the coarse-focus strategy and parameters of the fine-focus strategy respectively specify a number and a lateral position of autofocus reference points; and
wherein parameters of the coarse-focus strategy and parameters of the fine-focus strategy define when and with which focus method focus settings should be checked during an ongoing experiment.

9. The method according to claim 1,
wherein parameters of the coarse-focus strategy and the fine-focus strategy define an alteration of the coarse-focus strategy or fine-focus strategy in case that a focus cannot be determined; wherein the alteration specifies a modification of one or more of the following: a modification of a focus search range, a z-step size, lateral reference points or of an autofocus method.

10. The method according to claim 1,
wherein ambient characteristics are continuously monitored by means of at least one sensor and
wherein a time series of sensor measurements is used together with the experiment-specific information in vectorized form as input into the machine-learned model for a continuous correction of the parameters of the focus strategy.

11. The method according to claim 1,
wherein the focus strategy is defined iteratively, by at least:
i. capturing image data for verifying the focus strategy using the defined parameters of the focus strategy;
ii. deriving from the image data whether a modification of the defined parameters of the focus strategy should occur and, if so, which modifications should be carried out; and
iii. initiating a planned experiment using the focus strategy in cases where a modification of the defined parameters of the focus strategy is not required; or proceeding with i. with modified parameters of the focus strategy in cases where a modification of the defined parameters of the focus strategy is deemed necessary.

12. The method according to claim 1,
wherein, during performance of an experiment with the defined focus strategy, a checking and, where necessary, adjustment of the focus strategy is carried out, wherein the checking of the focus strategy is based on one or more of the following:
an image quality evaluation of at least one captured microscope image, a number of previous successful or failed autofocus attempts, and a position of found focus positions in relation to predetermined boundaries, and
wherein, in the event that a height variation of the sample is detected during the performance of the experiment, a modification of the focus strategy including an increasing of the number of lateral focus reference points is carried out.

13. The method according to claim 1,
wherein, during the data capture using the focus strategy, a checking and, where appropriate, adjustment of the focus strategy is carried out by at least:
evaluating, based on captured image data, whether a focusing is still possible if one or more image channels or focus methods are omitted, and omitting image channels or focus methods according to the evaluation.

14. The method according to claim 1,
wherein the machine-learned model includes a plurality of submodels learned by supervised learning, wherein one of the submodels calculates a selection of the focus method for the coarse-focus strategy, wherein another submodel calculates a selection of the focus method for the fine-focus strategy, wherein a still further submodel determines focus reference points spatially.

15. The method according to claim 1,
wherein some of the parameters of the focus strategy are determined with the aid of a database in which it is stored for experiment-specific information in vectorized form which values are to be used for parameters of the focus strategy.

16. The method according to claim 1,
wherein, after the data capture using the focus strategy, a test is carried out to determine whether the focus strategy or an experiment conducted with the focus strategy was successful, and if this is the case: adding values of the parameters of the employed focus strategy and associated experiment-specific information in vectorized form to training data of the machine-learned model.

17. The method according to claim 1,
wherein, in cases where a user modifies calculated parameters of the focus strategy and conducts an experiment with said modified parameters: adding the parameters of the employed focus strategy that have been modified by the user as well as associated experiment-specific information in vectorized form to training data of the machine-learned model.

18. A microscopy system including:
a microscope for image capture; and
a computing device that is configured to execute the computer-implemented method of claim 1.

19. A non-volatile, computer-readable data memory containing a computer program that includes instructions which, when executed by a computer, cause the computer to execute the method of claim 1.
